(19) United States
(12) Patent Application Publication
(10) Pub. No.: US 2025/0098657 A1
(43) Pub. Date: Mar. 27, 2025

(54) FLEXIBLE AND ADAPTIVE HORSESHOE FOR CLOVEN HOOVES OF ANIMALS

(71) Applicants: Evo Horse, S.L., Villaviciosa (Asturias) (ES); Shoe Floting, S.L., Villaviciosa (Asturias) (ES)

(72) Inventors: Florentino PEREIRA SUAREZ, Villaviciosa (Asturias) (ES); Albert VILLASEVIL FLORENSA, Villaviciosa (Asturias) (ES)

(21) Appl. No.: 18/727,970

(22) PCT Filed: Jan. 11, 2022
(86) PCT No.: PCT/ES2022/070006

§ 371 Date: Jul. 10, 2024

(51) Int. Cl. A01L 5/00; A01L 3/04

(52) U.S. Cl. CPC A01L 5/00; A01L 3/04

(57) ABSTRACT

A flexible and adaptable horseshoe for cloven hooves of animals, with a polyurethane base (1) adapted and fixed to the cloven hoof (9) of the animal by adhesive. The base (1) is elongated and flexible is formed by a plurality of equal primary units (3) joined in line one after the other, by flexible attachment. Each of the primary units (3) has a stud (5) with an upper base (11) for the support of the cloven hoof (9) and a lower base (12), and a flexible parietal flap (4) fixed obliquely to the upper base (11) of the stud (5), arranged in use on the lateral part of the cloven hoof (9). The parietal flaps (4) are configured to adapt to the shape of the cloven hoof (9) and close on the lateral part of the cloven hoof (9) when receiving the weight of the animal.

### FIELD OF THE INVENTION

The present invention pertains to the technical field of footwear and protection of hooves and cloven hooves of animals, and more specifically for equidae. The invention relates in particular to a flexible and adaptable horseshoe for cloven hooves of animals, which replaces rigid conventional horseshoes and provides permanent, flexible and completely self-adaptive protection for all types and sizes of hooves, being lightweight, comfortable, biomechanically respectful of the animal, and with a minimal impact on the functioning and development of the internal tissues of the cloven hoof.

### BACKGROUND OF THE INVENTION

Modern horses or Equus ferus caballus appeared in the arid environments of the planet, specifically in the steppes, about 3 million years ago after about 65 million years of non-linear evolution. Both their wild version (nowadays disappeared) and their feral version, rarely suffer from foot problems. This is mainly due to the selective processes to which they are subjected, the constant movement from their birth on all types of terrain and their diet based on semi-dry fodder grasses with a low percentage of short-chain carbohydrates but nutritionally very dense. The cloven hoof or hoof is nothing more than the protective frame of a set of highly specialized tissues. These tissues are designed to capture information about the environment (nature of the surface on which they pass), capture information about the limb (state of the tissues, proprioception . . . ), manage the energy of the impact through its partial absorption, its partial storage and its dissipation in the form of heat and fluid movement (mainly blood). When the horse is completely barefooted, it generally hits with the heels first, then with the base of the frog (the area with the most sensory capacity of the whole case or hoof), and then with the whole set of cover, sole and frog. Moment in which the digital bearing translates its compressive force towards the sides, causing the expansion of the ungular cartilages and of the entire case in its caudal portion. This generates a moment of high blood pressure in the area being released with the upward movement of the blood at the moment known as output or “breakover” (moment in which the body of the horse advances to the limb and the hoof loses its contact with the ground in its caudal portion pivoting on its most rostral portion or pliers). All this complex mechanism does not only affect the digit and its tissues, but has a strong impact on the health and well-being of the entire animal. So much so, that popularly there is the saying “No foot, no horse”.

Horses, in domestic environments, are not usually subject to the conditions set out above which, on the other hand, are appropriate for the species. This implies that on too many occasions:
Selective processes have little to do with factors such as rusticity, structural strength, resistance to diseases . . . and much to do with superfluous factors such as the color of the layer, the shape of the face . . . .
The constant daily movement on a large variety of different surfaces, although mainly abrasive all of them, from the moment of birth is highly restricted.
The diet is based on large amounts of by-products of the agri-food industry rich in short-chain carbohydrates (mainly starches) and nutritionally poor.

Each of these three factors separately, as well as the different possible combinations, cause alterations in the general health of the horse that are reflected in its digits, hooves or cloven hooves causing their malfunction in the form of impoverishments in the quality of the case, appearance of undesirable local infections, hypersensitivity to touch, lameness, etc. The lack of understanding of such processes throughout history and even today, has caused the “need” of the use of some protection mechanism created and added by man. The traditional means of protection for the hooves of horses par excellence, appeared during the Middle Ages and became popular in the Western world from the Industrial Revolution. Said means of protection is what is commonly known as the “horseshoes”.

In its classic version, these protections are made from different metal alloys that gives them absolute rigidity and forces the practitioners who work with them (the blacksmiths) to adapt them by means of their forging. They are permanently fixed to the cloven hoof or hoof by the use of metal nails that, after having passed through the corresponding holes of the horseshoes, are introduced at an angle into the structure of the hoof or cloven hoof, known as the wall or lid. After having pierced this structure, the nail tips are cut, bent down and tightly tightened on the wall, in what is known as “riveting”. Said classic version of the horseshoes has the following drawbacks:
It implies that the practitioners who work with this material and move to the different facilities through the use of the car, have to acquire a trailer and adapt it or adapt the vehicle itself so that it can house and feed all the necessary equipment (portable gas furnace, column drill, belt sanding . . . ), with the consequent investment that this implies for the practitioner.
It assumes that practitioners must transport a large and heavy stock in their trailers or vehicles, greatly increasing fuel consumption and the release of CO2 into the atmosphere and also increasing the severity of injuries in the event of a traffic accident.
The need to transform or adapt these horseshoes by forging (heating in the furnace and subsequent adaptation by blows with hammers and masses of the still hot material), increases the incidence of injuries (mainly located in hands, wrists, elbows and lower back) and therefore the reduction of the “useful” or working life among the practitioners using them. In addition, this need implies that the practitioner must devote 90% of the time with his client to the transformation/adaptation of the horseshoes, often reducing his attention in terms of the work of the cloven hoof or hoof.
By being used as a permanent support (they remain attached to the hoof or cloven hoof until its renewal, which should occur between 4 and 6 weeks after its placement), they are built of a rigid, heavy material and fixed by the use of nails, they end up producing:
Severe atrophies of the soft tissues (digital bearing and ungular cartilage) laying the foundations for the appearance of a huge number of pathologies, both local and systemic.
Atrophies and alterations in the different portions of the hard or keratinized part such as the atrophies of the lid, the infections of the central groove of the frog and/or the sweet itch or undesirable infections that are initiated and concentrated around the holes produced by the nails (also known as “nail stump”).
Bone and permanent malformations derived from osteolytic processes of the third phalanx.
Instantaneous reductions in intracapsular blood flow that cause the alteration of the sensory capabilities of said structure, as well as the management of the energy of the impact, facilitating the appearance of free or unmanaged energy that will increase the presence of injuries of different nature, according to the conformation of each animal (osteoarthritis, tendinopathies, navicular syndrome . . . )
Permanent alterations of the vascular structure of the lower limbs derived from the vibrational frequency of these materials with the impact against the ground (especially on hard surfaces). Pathology known as the “Hammerman effect”.
Decrease in the sporting potential of the horse because the heart must increase its vacuum or suction force to manage to displace the blood found in the lower part of the limbs, thus altering the cardio-respiratory performance of the animal.
Increase in the presence of injuries due to the artificial kinetic forces derived from the increase in the weight of the structure and the artificial lever forces that are generated by the thickness of the horseshoe itself, the nature or design of the edge of the latter and by the overgrowth of the lid (being more noticeable at the end of the horseshoe cycle) that is generated as a result of the wear protection offered by said solutions.

The drawbacks for the animals of such classical protections are so widely known and accepted that horseshoes are commonly described as “a necessary evil”. The recognition of what has been mentioned above has made that today, they are looking for a way to improve this traditional version. Some of the alternatives that are emerging in the market are, for example:
Horseshoes made from the use of flexible and absorbent materials (mainly polymers such as different plastics and rubbers) in a single or combined manner, are shown in documents U.S. Pat. No. 6,349,773B1 and U.S. Pat. No. 6,915,859B2.
The horseshoes partially or totally covered by flexible and absorbent materials (mainly polymers such as different plastics and rubbers) uniquely or in combination, but with a web or sheet of metal alloy inside, are shown in documents US20050034877A1, U.S. Pat. No. 7,793,734B2, U.S. Pat. No. 9,781,913B2, US20120193107A1, US2005236165A1 and AU5397501A.

The use of polymers uniquely or in combination with a metal web, as discussed above, has allowed:
Improve transverse and longitudinal flexibility (in some models), reducing the atrophying effect on soft tissues since, although their total and normal operation is not allowed, they are not 100% blocked either (which was the case in the traditional or classic version of the horseshoes).
Reduce the energy of the impact because of the use of absorbent materials. As a result, the side effects resulting from the amplification of the impact force produced by the metal (mainly on hard surfaces) have been reduced.
Eliminate the appearance of injuries on the vascular tissue of the lower part of the limbs, related to the vibration of the metal and derivative thereof, the “Hammerman effect”.

In addition, these modern versions usually allow the anchoring to the hoof or cloven hoof, either by the use of nails or the use of adhesives of different nature (generally polyurethane resins or cyanoacrylates). In this regard, it must be borne in mind that:
When nails are used for their fixing, the versions with metallic core take advantage of the purely plastic ones since they allow a better distribution of the forces exerted by the nails, thus reducing their risk of loss, as well as the atrophy of the lid (outer or parietal layer that covers the cloven hoof or hoof) derived from the concentration of the vibration around the nail.
When adhesives are used for fixing, the effect of the nails on the structure can be eliminated. In such a case, both solutions are useful.

Although, as can be appreciated, the modern versions represent a noticeable improvement versus the classic or traditional version, there are still drawbacks:
For the versions that are fixed to the hoof or cloven hoof through nails, the drawbacks, already explained and derived from the use of these continue to be assumed.
For the versions that are fixed by the use of adhesives and mainly partially flexible resins, we have the disadvantage that the lid can be damaged both by mechanical factors (work of preparation for gluing), chemical (of the adhesive itself) and microbiological (mainly in those versions with large parietal flaps that partially or totally covers the lid generating artificial conditions of anaerobiosis).
For both versions, those consisting only of polymers and the mixed ones (metal web with partial or total coating by polymers of different nature):
It can continue to have an excessive weight that contributes to the appearance of injuries due to overstretching of the ligamentous structures.
The adaptability offered by the traditional version is lost through its forging or its adaptation to the morphometry of the specific hoof, which requires advanced skills and/or is a huge waste of time.
There are still problems deriving from the permanent supports such as the overgrowth of the case due to zero wear and its consequent levers.
It is still mandatory to have a large size since the combination of the 2 basic variables, length and width, typical of the hooves, cases or cloven hooves.

A flexible and adaptable horseshoe for cloven hooves of animals is therefore desirable that provides permanent, flexible and completely self-adaptive protection for all types and sizes of cloven hooves, avoiding the drawbacks existing in prior art systems.

### DESCRIPTION OF THE INVENTION

The present invention solves the problems existing in the prior art by means of a flexible and adaptable horseshoe for cloven hooves of animals, which constitutes a permanent type protection, which has a base made of thermoplastic polyurethane which is adapted and fixed to the cloven hoof of the animal by means of adhesive means of different nature. The invention is preferably used for cloven hooves of equines, although it could be used for other animals.

The base of the horseshoe is elongated and flexible, presenting a first end and a second end. Likewise, the base is composed of a plurality of primary units which are the same and are joined in line one after the other. The adjacent primary units are joined to each other by flexible attachment means. In this way, a single highly flexible body is achieved in all directions, thus allowing instant self-adaptation to any morphology or condition that the cloven hoof on which it is arranged may present. In addition, in this way, when the base is extended it is of straight configuration, which facilitates its production and storage.

Each of the primary units has a cue formed by an upper base for the support of the hoof of the animal and a lower base, and a flexible parietal flap fixed obliquely to the upper base of the stud, which when the horseshoe is in use is arranged on the lateral part of the cloven hoof. These parietal flaps are configured to adapt to the shape of the cloven hoof and close on the lateral part of said hoof when receiving the weight of the animal, guaranteeing the closure of the horseshoe on the cloven hoof and avoiding the opening of the latter because of the weight of the animal.

In particular, the lower part of the stud under the outer edge of the cloven hoof in use is rounded to facilitate the bearing and interaction between the cloven hoof and the ground, especially during the output phase or “breakover”.

According to a particular embodiment, the stud of the primary units has, arranged at its lower base, a hole for the insertion of metallic complements, known as calks, which allow to increase the traction on slippery surfaces such as asphalt, mud or ice.

Preferably, the upper base of the stud has a rough surface with relief, forming cylindrical reliefs or grooves, to increase the distribution of the adhesive and the friction between the cloven hooves and the studs, thus increasing the stability of the attachment between both surfaces.

According to a particular embodiment of the invention, each of the primary units has a flexible sole flap that is fixed to the upper base of the stud, on the side opposite the parietal flap, and aligned with said upper base of the stud, being arranged in use at the base of the cloven hoof, for the support of said cloven hoof.

Preferably, the sole flap of the primary units can have a triangular shape to allow adaptability avoiding the appearance of undesirable folds, although it can have other shapes adapted to particular needs.

Likewise, the parietal flap of the primary units may also have a triangular shape, although it may also have other shapes adapted to particular needs.

Preferably, both the parietal and sole flaps may have through-holes that pierce the structure in different directions, to allow a better anchorage between the flaps and the cloven hoof of the animal, since a “riveting effect” may be generated by the adhesive in the through-holes.

According to a preferred embodiment of the invention, the attachment means between adjacent primary units are formed by a flexible cylindrical body arranged between the studs of said adjacent primary units. Preferably, in addition to the flexible cylindrical body between studs, the attachment means between adjacent primary units may have a curved and flexible linear element arranged between the parietal flaps of said adjacent primary units. This attachment between the different adjacent segments or primary units allows the collapse (or self-closing effect) against the wall of the cloven hoof when the animal loads its weight against its structure, being said base compressed between the descending force (applied by the animal) and the reactive force (applied by the ground). In this way, its closure is greatly facilitated and the risk of loss is reduced. The flexible cylindrical body between studs allows the bending of the invention in all directions giving the structure an instant self-adaptive capacity. The curved linear element between the parietal flaps provides elasticity to the joint and bending capacity, thus ensuring the joint work of all the parietal flaps, the self-closing effect, and the instant self-adaptation to the different angles that the hoof of the animal can present in its different areas, achieving optimal contact between each of the parietal flaps and the surface of the cloven hoof, thus allowing to reduce the amount of adhesive to be used and facilitating the placement of the horseshoe on the cloven hoof.

As for the adhesive means that attach the base to the cloven hoof of the animal, these consist of glues of different nature, mainly in the fluid state. Essentially the adhesive media are put on the parietal flaps, for their fixation to the cloven hoof. If necessary, optionally, and to improve the fixation they can also be put on the studs and the sole flaps.

According to different particular embodiments of the invention, the horseshoe may feature closing means for connecting the first end and the second end of the base in use adapted to the shape of the cloven hoof, and thereby closing said base to the cloven hoof. The interaction between the base and the closing means is mechanical.

In particular, these sealing means feature a substantially flat central body for use in covering and protecting the frog of the cloven hoof of the animal, and a plurality of arms extending radially from the central body and in use connect with the ends of the base by connecting means. These closing means with central body and radial arms give greater stability to the whole and improve the stimulation and protection of the foot tissues, the most important being the digital bearing and the ungular cartilages, thus avoiding their atrophy during the use of said invention.

Preferably, the central body may have recesses and/or grooves in different directions to add traction capabilities and thus reduce the possible occasional slips that may occur during walking and may be a source of injury for the animal.

According to the foregoing embodiment, the connecting means of the arms to the ends of the base have shoulders arranged at the ends of the arms and openings arranged in the studs for the insertion of the shoulders of the ends of the arms.

Optionally, to increase the fixation of the base to the cloven hoof, adhesive means can also be put on the central body to facilitate its attachment to the cloven hoof.

In this way, the horseshoe of the present invention solves the problems that existed in the systems of the prior art, both for the practitioner who puts the horseshoes, as for the horse in general and especially for his cloven hooves.

On the one hand, the horseshoe of the present invention allows the practitioner:
To drastically reduce its economic investment both in the necessary equipment and in the adaptation of the trailer or vehicle for the correct work of traditional horseshoes, since it will only require the necessary tools for the correct trimming of the hoof or cloven hoof and a bottle of the appropriate adhesive.
To ostensibly reduce its CO2 footprint and mitigate possible injuries in the event of a traffic accident by drastically decreasing the weight transferred. Thanks to the reduction of the equipment, the minimal weight of the present invention and the feature “one fits all” (a single unit formed by a set of primary units arranged in line allows to cover a high range of widths and lengths by the simple process of cutting or eliminating excess or surplus material).
To put all their attention and time (90%) in the work of the hoof or cloven hoof, offering the horse better results and extending the professional's useful or productive life. This is achieved thanks to the speed and simplicity in the application of said invention.

On the other hand, the great flexibility derived from both the material and the design, combined with its great ability to absorb the impact, give the horseshoe of the present invention the ability to:
Adapt autonomously (without the need to do anything) and optimally to any shape and condition of the animal's hoof or cloven hoof instantly.
Minimize the negative effect that other solutions discussed have on the correct functioning of the internal structures of the animal's digit, avoiding its atrophy and the problems deriving from it (atrophies of soft tissues, bone malformations, Hammerman effect, reduction of the sporting potential of the animal, etc.).
Generate a “natural” interaction with the ground, minimizing undesirable levers.
The present horseshoe allows the correct protection at the same time as the optimal stimulation of the different structures of the hoof or cloven hoof, being the most important of these, the frog, the sole and the lid. In addition, it achieves this by avoiding the risk of embedding stones or other foreign objects, which frequently occurs with the prior art solutions discussed above.
In addition, its small weight allows to avoid or reduce to the minimum the appearance of injuries due to overstretching of the related ligamentous structures, as discussed above, with the excessive weight located in the distal portion of the limb of the animals in question.
Its anchoring mechanism by the use of a special adhesive, allows to avoid all the side effects derived from the mechanical anchoring by the use of nails.

Likewise, the present horseshoe has the following advantages:
Allow the three-dimensional deformation of all the elements of the case, both when the horse is in station, and when it is performing any type of movement or activity on any type of ground and at any speed.
Provide adequate protection against wear and tear, shock and any other aggression that may be caused on the sole (or bottom) surface of the hoof of the animals.
Allow the correct functioning of internal tissues, thus avoiding their atrophy and promoting their development, functionality and healthiness.
Eliminate the need or obligation of sizing since a single unit is able to cover a high range of combinations between the length and width, which make up what we know as “sizes”.
Provide a protector for animal hooves that is instantly self-adaptive to any asymmetry or shape of the hoof in all its parts, allowing the correct functioning of all parts of the limb, avoiding interfering in the ranges of movement of the different joints and ligaments that make it up as well as the appearance of unwanted levers that will cause unnecessary stress on the tissues of the limb.
Ensure an intimate, compact, flexible and stable connection between the cloven hoof or hoof and this protection, providing the animal with a feeling of safety and comfort, both static and at any phase of the walking, but especially during the take-off and landing of the cloven hoof.
Avoid the accumulation of debris and the embedding of stones and other objects due to its design and high flexibility.
Avoid the presence of elements that can directly injure the case and/or the limbs in case of interference.
Allow the addition of extra traction elements widely used in snow conditions and/or in jumping and raid competitions in the open air, known as calks.
Have an extremely light weight to reduce additional accelerations of the limb and avoid unnecessary tensions in the soft tissues of the latter.
Present a design of flaps attached to each other that close against the case when the horse loads its weight in said solution, reducing the risk of loss and greatly facilitating its application.

In summary, the horseshoe of the present invention replaces the horseshoes of the prior art, both in their traditional and modern versions, since due to the materials used for their construction, such as their design and application, they allow it to be an ultra-light, instantly self-adaptive solution, of single size and of very simple application that in turn gives the animal that requires it optimal protection, with the minimum negative impact on the internal structures of the cloven hoof while remaining friendly with the correct functioning of the latter and its interaction with the ground, both static and dynamic.

### BRIEF DESCRIPTION OF THE DRAWINGS

In order to facilitate the understanding of the invention, an embodiment of the invention referring to a series of figures will now be described by way of illustration but not limitation.

FIGS. 1, 2 and 3 show an anterior perspective, posterior perspective and inferior perspective respectively of an embodiment of a horseshoe of the present invention arranged on the cloven hoof of a horse.

FIGS. 4, 5 and 6 show an anterior perspective, posterior perspective and inferior perspective respectively of another embodiment of a horseshoe of the present invention arranged on the cloven hoof of a horse that includes closing means for the connection of the ends of the base.

FIGS. 7, 8 and 9 show a front anterior view, a front posterior view and a bottom plan view respectively of an embodiment of the base of FIGS. 1 to 6, separated from the cloven hoof and in its extended form.

FIGS. 10, 11, 12, and 13 show in detail a front anterior view, a front posterior view, a bottom plan view, and a side view of an embodiment of the horseshoe base primary unit of FIGS. 1 to 9.

FIGS. 14, 15 and 16 show an anterior front view, a posterior front view and a perspective view of an embodiment of the closing means of FIGS. 4, 5 and 6.

In these figures reference is made to a set of elements which are:
1. base of the horseshoe
2. Closing means
3 primary units of the base
4. primary unit of parietal flap
5. stud of primary unit
6. sole flap of the primary unit
7. central body of the closing means
8. arms of the closing means
9. cloven hoof
10. flexible cylindrical body of the attachment means between primary units
11. upper base of the stud
12. lower base of the stud
13. hole in the lower base of the stud
14. through-holes in the flaps
15. first end of the base
16. second end of the base
17. curved linear element of the attachment means between primary units
18. grooves of the central body
19. shoulders of the connecting means arranged at the ends of the arms
20. openings of the connecting means arranged in the studs

### DETAILED DESCRIPTION OF THE INVENTION

The object of the present invention is a flexible and adaptable horseshoe for cloven hooves of animals, particularly for horses, although it can be used for other animals, such as different types of cattle.

As can be seen in the figures, the horseshoe has a base (1) made of thermoplastic polyurethane, which in use is adapted and fixed to the cloven hoof (9) of the animal by means of adhesive means.

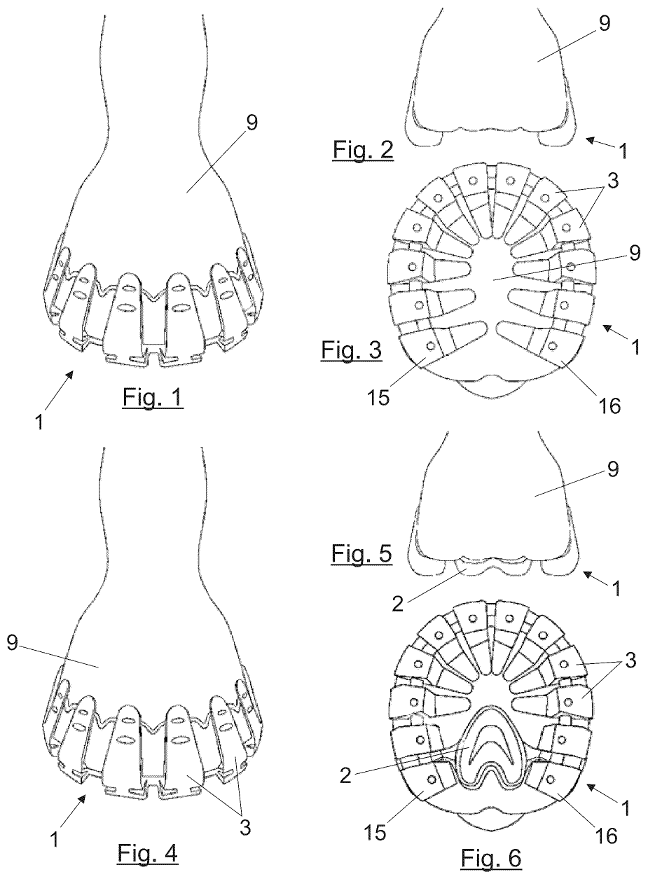

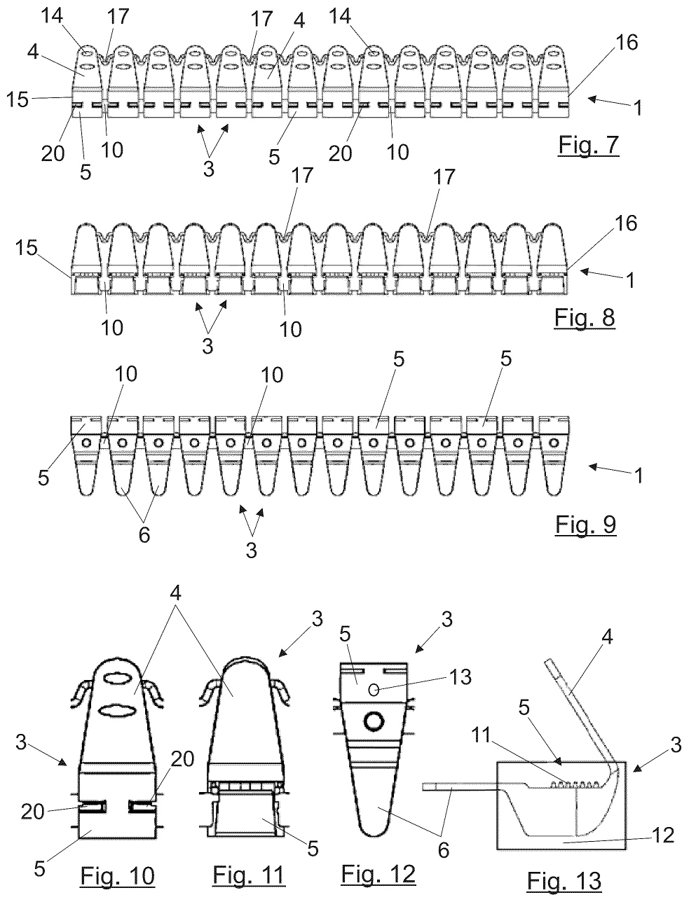

The base (1) is elongated and flexible, and has a first end (15) and a second end (16), as can be seen in FIGS. 7, 8 and 9. These FIGS. 7, 8 and 9 show the base (1) in an extended form, while FIGS. 1 to 6 show it in a closed form on the cloven hoof (9) of the animal. The base (1) is formed by a plurality of equal primary units (3) joined to each other in line one after the other, the adjacent primary units (3) being joined to each other by flexible attachment means. In this way, a single highly flexible body is achieved in all directions, thus allowing instant self-adaptation to any morphology or condition that the cloven hoof (9) on which it is arranged may present.

As seen in FIGS. 10 to 13, each of the primary units (3) comprises a stud (5) with an upper base (11) for the support of the cloven hoof (9) and a lower base (12), and a flexible parietal flap (4) fixed obliquely to the upper base (11) of the stud (5), being arranged in use on the lateral part of the cloven hoof (9) of the animal. The parietal flaps (4) are configured to adapt to the shape of the cloven hoof (9) and close on the lateral part of said cloven hoof (9) when receiving the weight of the animal. This arrangement is clearly seen in FIGS. 1 and 4. This facilitates the bearing and interaction between the cloven hoof and the ground,

In particular, the lower part of the stud (5) under the outer edge of the cloven hoof (9) is rounded, as can be seen in FIG. 13.

According to a particular embodiment, the stud (5) of the primary units (3) has, arranged at its lower base (12), a hole (13), as can be seen in FIGS. 9 and 12, for the insertion of metallic complements or calks, which allow to increase the traction on slippery surfaces such as asphalt, mud or ice.

Preferably, the upper base (11) of the stud (5) has a rough surface with relief, forming cylindrical reliefs or grooves, to increase the surface for the distribution of the adhesive and also to raise the friction between the cloven hooves (9) and the studs (5), thus increasing the stability of the attachment between both surfaces.

According to a particular embodiment of the invention, each of the primary units (3) has a flexible sole flap (6) fixed to the upper base (11) of the stud (5), on the side opposite to the parietal flap (4), and aligned with said upper base (11) of said stud (5), so that in use it is arranged at the base of the cloven hoof (9) for the support of said cloven hoof (9).

Preferably, both the sole flap (6) and the parietal flap (4) can have a triangular shape to allow adaptability avoiding the appearance of undesirable folds, although they could have any other shape adapted to the particular needs.

Likewise, both the sole flaps (6) and the parietal flaps (4) may have through-holes (14) in different directions, to allow a better anchorage between the flaps (4,6) and the cloven hoof (9) of the animal, since a “riveting effect” may be generated by the adhesive in the through-holes.

According to a preferred embodiment of the invention, the attachment means between adjacent primary units (3) are formed by a flexible cylindrical body (10) arranged between the studs (5) of the adjacent primary units. Preferably, in addition to the flexible cylindrical body (10) between studs (5), the attachment means between adjacent primary units (3) may have a curved and flexible linear element (17) arranged between the parietal flaps (4) of said adjacent primary units (3). FIGS. 1, 4 and 8 show this preferred embodiment of the attachment means including the cylindrical body (10) flexible between studs (5) and the curved and flexible linear element (17) between parietal flaps (4). The flexible cylindrical body (10) between studs (5) allows the bending of the invention in all directions giving the structure an instant self-adaptive capacity. The curved linear element (17) between the parietal flaps (4) provides elasticity to the joint and bending capacity, thus ensuring the joint work of all the parietal flaps (4), the self-closing effect, and the instant self-adaptation to the different angles that the cloven hoof (9) of the animal can present in its different areas, achieving optimal contact between each of the parietal flaps (4) and the surface of the cloven hoof (9), thus allowing to reduce the amount of adhesive to be used and facilitating the placement of the horseshoe on the cloven hoof (9).

As for the adhesive means that attach the base (1) to the cloven hoof (9) of the animal, these consist of glues of different nature, mainly in the fluid state. Essentially the adhesive media are put on the parietal flaps (4), for their fixation to the cloven hoof. If necessary, optionally, and to improve the fixation they can also be put on the studs (5) and the sole flaps (6).

According to different embodiments of the invention, the horseshoe has closing means (2) for connecting the first end (15) and the second end (16) of the base (1) when in use is adapted to the shape of the cloven hoof (9), and being able to close said base (1) to the cloven hoof (9).

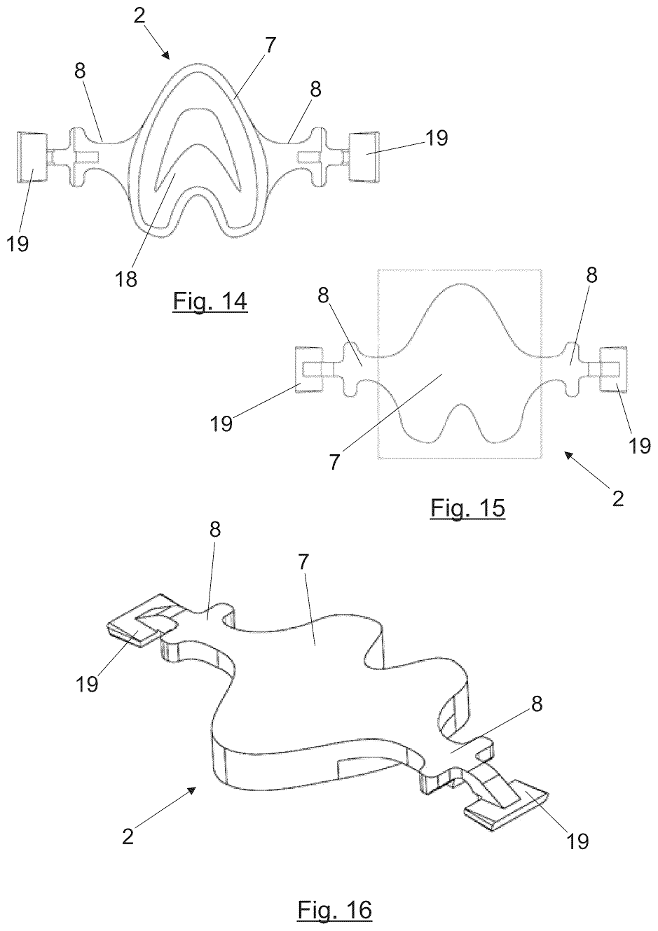

Preferably, these sealing means (2) have a central body (7) substantially flat for use in covering and protecting the frog of the cloven hoof (9), and a plurality of arms (8) extending radially from the central body (7) and in use connect with the ends (15,16) of the base (1) by connecting means. FIGS. 14, 15 and 16 show this preferred embodiment of the closing means (2), which include the central body (7) and specifically two arms (8) extending radially from said central body (7). These closing means (2) give greater stability to the whole and improve the stimulation and protection of the foot tissues, the most important being the digital bearing and the ungular cartilages, thus avoiding their atrophy during the use of said invention.

According to the foregoing embodiment, these connecting means of the arms (8) to the ends (15,16) of the base (1) have shoulders (19) at the ends of the arms (8) and openings (20) in the studs (5) for the insertion of said shoulders (19).

According to a preferred form of the previous embodiment, the openings (20) are arranged on the sides of the studs (5), the arms (8) being arranged between two adjacent studs (5), so that each shoulder (19) is inserted into the openings of both adjacent studs (5), as can be seen in FIG. 6.

Preferably, the central body (7) of the closing means (2) may have a triangular shape, although they could have any other shape that fulfilled the purpose of covering and protecting the frog of the cloven hoof (9).

In addition, said central body (7) may have grooves (18) in different directions to add traction capabilities and thus reduce the possible occasional slips that may occur during walking.

Optionally, to increase the fixation of the base (1) to the cloven hoof (9), adhesive means can also be put on the central body (7) to facilitate its attachment to the cloven hoof (9).

1. A flexible and adaptable horseshoe for cloven hooves of animals, comprising a base (1) made of thermoplastic polyurethane configured to be adapted and fixed to the cloven hoof (9) of the animal by adhesive means, wherein
the base (1) is elongated and flexible, and comprises a first end (15) and a second end (16), said base (1) being formed by a plurality of equal primary units (3) joined in line one after the other, the adjacent primary units (3) being joined to each other by flexible attachment means,
each of the primary units (3) comprising
a stud (5), comprising an upper base (11) configured for supporting the cloven hoof (9) and a lower base (12),
a flexible parietal flap (4) fixed obliquely to the upper base (11) of the stud (5), being arranged in use on the lateral part of the cloven hoof (9),
the parietal flaps (4) are configured to adapt to the shape of the cloven hoof (9) and close on the lateral part of said cloven hoof (9) when receiving the weight of the animal.

2. The flexible and adaptable horseshoe for cloven hooves of animals according to claim 1, wherein each of the primary units (3) comprises a flexible sole flap (6) fixed to the upper base (11) of the stud (5), on the side opposite to the parietal flap (4), and aligned with said upper base (11) of said stud (5), being arranged in use at the base of the cloven hoof (9) and configured for the support of said cloven hoof (9).

3. The flexible and adaptable horseshoe for cloven hooves of animals according to claim 2, wherein the sole flap (6) of the primary units (3) has a triangular shape.

4. The flexible and adaptable horseshoe for cloven hooves of animals, according to claim 1, wherein the parietal flap (4) of the primary units (3) has a triangular shape.

5. The flexible and adaptable horseshoe for cloven hooves of animals, according to claim 1, wherein the lower part of the stud (5) under the outer edge of the cloven hooves (9) in use, is rounded.

6. The flexible and adaptable horseshoe for cloven hooves of animals according to claim 1, wherein the stud (5) of the primary units (3) comprises, arranged at its lower base (12), a hole (13) configured for the insertion of metallic complements.

7. The flexible and adaptable horseshoe for cloven hooves of animals according to claim 1, wherein the parietal flaps (4) comprise through-holes (14).

8. The flexible and adaptable horseshoe for cloven hooves of animals according to claim 2, wherein the sole flap (6) comprise through-holes (14).

9. The flexible and adaptable horseshoe for cloven hooves of animals according to claim 1, wherein the upper base (11) of the stud (5) comprises a rough embossed surface.

10. The flexible and adaptable horseshoe for cloven hooves of animals according to claim 1, wherein the attachment means between adjacent primary units (3) comprise a flexible cylindrical body (10) arranged between the studs (5) of said adjacent primary units (3).

11. The flexible be and adaptable horseshoe for cloven hooves of animals according to claim 1, wherein the attachment means between adjacent primary units (3) comprise a curved and flexible linear element (17) arranged between the parietal flaps (4) of said adjacent primary units (3).

12. The flexible and adaptable horseshoe for cloven hooves of animals according to claim 1, comprising closure means (2), configured to connect to each other the first end (15) and the second end (16) of the base (1) in use adapted to the shape of the cloven hoof (9).

13. The flexible and adaptable horseshoe for cloven hooves of animals according to claim 12, wherein the closing means (2) comprise
a substantially flat central body (7) configured for use to cover and protect the frog of the cloven hoof (9),
and a plurality of arms (8) extending radially from the central body (7) and configured for use of connecting with the ends (15,16) of the base (1) by connecting means.

14. The flexible and adaptable horseshoe for cloven hooves of animals according to claim 13, wherein the connecting means of the arms (8) to the ends (15,16) of the base (1) comprise
shoulders (19) arranged at the ends of the arms (8), and
openings (20) arranged in the studs (5) configured for the insertion of the shoulders (19) of the ends of the arms (8).

15. The flexible and adaptable horseshoe for cloven hooves of animals according to claim 14, wherein the openings (20) are arranged on the sides of the studs (5) and the arms (8) are arranged between two adjacent studs (5) each shoulder (19) being inserted into the openings of both adjacent studs (5).

16. The flexible and adaptable horseshoe for cloven hooves of animals according to claim 13, wherein the central body (7) has a triangular shape.

17. The flexible and adaptable horseshoe for cloven hooves of animals according to claim 13, wherein the central body (7) of the closing means (2) has grooves (18).
